(19) United States
(12) Patent Application Publication
(10) Pub. No.: US 2018/0012422 A1
(43) Pub. Date: Jan. 11, 2018

(54) FRANKING SYSTEM WITH FUNCTIONS FOR REFUND AND RE-PRINT

(71) Applicant: FRANCOTYP-POSTALIA GMBH, Berlin (DE)

(72) Inventors: Clemens Heinrich, Oranienburg (DE); Dirk Rosenau, Berlin (DE)

(73) Assignee: FRANCOTYP-POSTALIA GMBH, Berlin (DE)

(21) Appl. No.: 15/370,335

(22) Filed: Dec. 6, 2016

(30) Foreign Application Priority Data
Dec. 8, 2015 (DE) 102015121318.4

(51) Int. Cl. G07B 17/00; G01G 19/00

(52) U.S. Cl. CPC G07B 17/00362; G01G 19/005

(57) ABSTRACT

In a franking system and method for franking of individual items of correspondence by a sender, a weighing device determines the weight of an item of correspondence and determines a postage amount associated with the item of correspondence. A printing device prints a value imprint corresponding to the postage amount and prints a code associated with the item of correspondence that represents a unique identity number onto the item of correspondence. A control computer creates a data set associated with the item of correspondence. A memory is associated with the control computer, in which the data set is stored in a file associated with the sender. The data set includes the identity number of the item of correspondence and the postage amount that is to be debited on the part of the delivery service from the sender using the data set. A registration unit is associated with the control computer, which registers the possibility of the presence of a misprint and, given the presence of a possible misprint, writes to a first data field of the data set with information about the presence of the possible misprint.

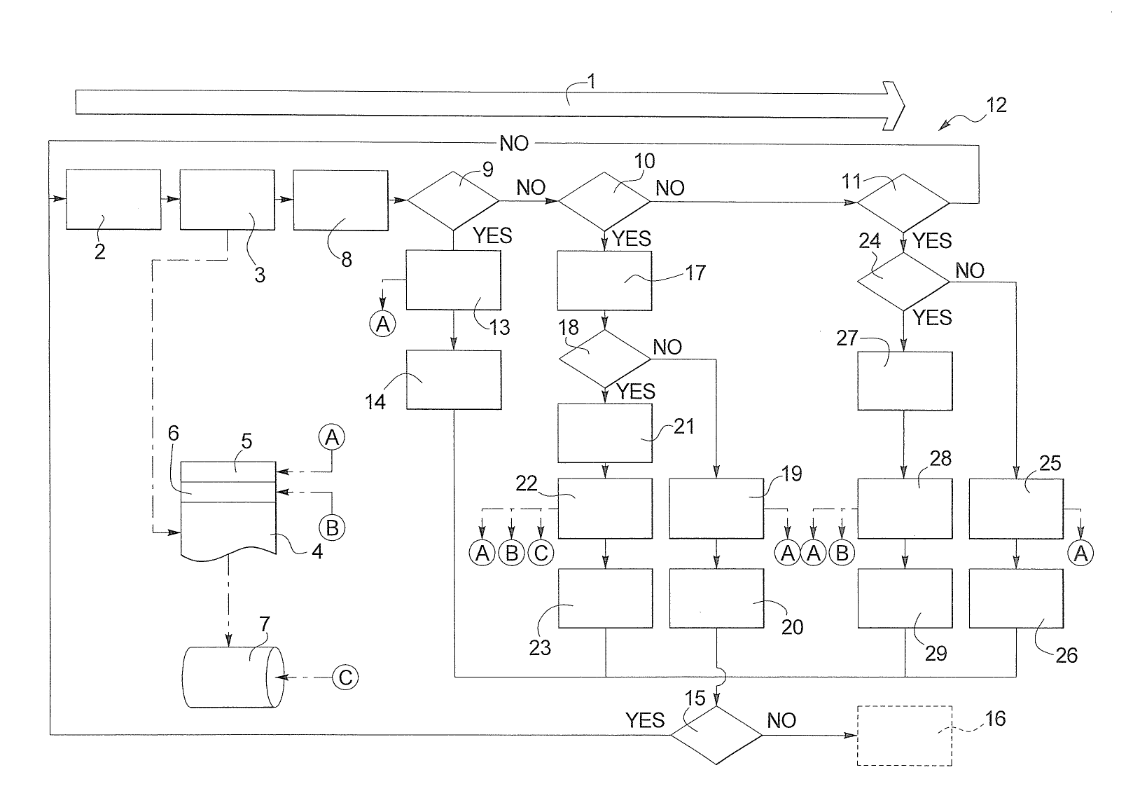

### BACKGROUND OF THE INVENTION

### Field of the Invention

The invention concerns franking systems for franking of individual items of correspondence by a sender. The invention also concerns a method to be implemented with such a franking system for franking of individual items of correspondence.

### Description of the Prior Art

A franking system typically has a weighing device to determine the weight of an item of correspondence and to determine a postage amount associated with the item of correspondence. In addition, a printing device is present for printing a value imprint corresponding to the postage amount and a code, in the form of a one-dimensional or two-dimensional barcode, that represents an identity number uniquely associated with the item of correspondence. The value imprint may also be encoded in the code. A control computer creates a data set associated with the item of correspondence, with a memory to store the data set is associated with the control computer. The data set, which includes the unique identity number of the item of correspondence and the postage amount that is to be debited from the sender on the part of the delivery service using the data set, is stored in a file associated with the sender.

As is known, franking machines are more than just special printers for printing a value imprint to items of correspondence. Franking machines also serve as payment instruments so that the value imprints—just as with conventional postage stamps—are payment records with which the sender pays for the carriage of the item of correspondence and its delivery to the addressee. In order to satisfy the authorized request of the delivery service for sufficient payment, it is known for the sender (as the operator of a franking machine) to apply a credit to an account associated with the sender and/or with the franking machine, this account being authorized by the delivery service (in particular the appropriate postal authority) and is debited corresponding to each printing of a value imprint. The sender makes an advance payment to fill the account.

On the other side, the sender has the justified interest in charging the account only with successful value imprints, thus with those that were actually imprinted with the correct value and legibly on the item of correspondence, and that therefore form the basis of a successful delivery.

Automatic franking with a franking machine, however, may lead to errors of different types. The franking process may be completely terminated for technical reasons, after the debiting has occurred but before it actually led to an imprint (error situation: “debiting without printing”). The operator may also terminate the franking process for any reason, for example because the operator has recognized an incorrect postage amount or because the envelope has been damaged (error situation: “termination by operator”). An additional error case is an illegibly produced imprint (error situation: “illegible imprint”). In all of these cases, the sender would like to be able to cancel the debiting from the sender's account (“refund”) or possibly to be able to produce a replacement new imprint without additionally charging the sender's account (“reprint”).

Due to the high potential for fraud, the possibilities for both reprint and refund are very limited. Reimbursements (refunds) are thus presently processed by the sender collecting the sender's incorrect imprints as evidence, and exchanging these at a physical facility of the postal authority for the corresponding revaluation of the sender's account. This process, which may also be performed by mail, is sometimes considered complicated by senders. Moreover, functions in franking systems are known that, under very strict requirements, enable the production of a reprint in the event of error.

A method for handling errors in the franking workflow after the debiting has occurred is known from DE 10 2004 032 323 A1. This method enables a reimbursement for unusable printed franking imprints. Error incidents are registered, and the corresponding postage values are added into an error sum. This error sum information is then transmitted in a report to a refund authority.

### SUMMARY OF THE INVENTION

An object of the present invention is to provide a franking system and a corresponding method for improving mechanical franking of individual items of correspondence, so that reimbursement of postage amounts charged without justification, which were charged to the sender of items of correspondence as the operator of the franking machine without the proper sending of such items of correspondence, is facilitated, while ensuring the necessary security (refund). In addition, the possibility of the legitimate production of a new value imprint on the item of correspondence after an incorrect value imprint should be achieved (reprint).

Accordingly, the basis of the invention is that a first data field is provided in each data set that is associated with an individual item of correspondence, in which data field information is entered that designates that this item of correspondence was possibly provided with a misprint. The franking system according to the invention accordingly enables the entry, in the first data field of the data set, of the information about the presence of a possible misprint after it has been registered as such. Information about the registered error case may also already have been entered into the first data field.

The registration of a misprint according to the invention accordingly already includes the possible presence of a misprint. It therefore involves the registration of a “misprint candidate”. Whether the misprint candidate is actually a misprint may then subsequently be verified automatically, or by inspection by the sender. If a misprint candidate has been identified as an actual misprint, an appropriate error handling may then take place. The term “misprint” is used in the following so as to include the potential “misprint candidates”.

An important feature of the invention is that the effectively certified electronic proof is provided via the data set and the first data field, with which proof the outlay for reimbursement can be reduced to a significant extent. The submission of the data set as evidence of a misprint may accordingly be used without this misprint needing to be physically submitted. The use of the data set additionally offers the guarantee of a reprint if a (likewise certified) electronic attribute is present that is associated with the data set.

This assurance results in the file associated with the sender being sent to the delivery service with data sets (“records”) of all items of correspondence that are successfully and unsuccessfully franked by the sender. The sending occurs from the franking system via the Internet to a portal (which may be provided by the manufacturer) at the delivery service. The file therefore includes the data sets of both all items of correspondence of the sender that are to be delivered and those for which a postage amount has been debited that, however, are not to be delivered due to an error (detectable in the correspondingly described first data field). The delivery service now has the possibility of using this file to compare the items of correspondence that it has actually delivered with the items of correspondence to be delivered according to the file. If, in the delivery, the delivery service discovers an item of correspondence that belongs to the group of items of correspondence that are not to be delivered (because they have an error and possibly have already been refunded), there can then be corresponding consequences.

The invention thus uses the registration, storage and transfer of the complete information for each imprint, in particular in an “Indicia Creation Record” (ICR, corresponding to the ADS). Each ICR may be transmitted from the franking system (in particular via the portal provided by the manufacturer and accessible via the Internet) directly to the delivery service, such as the postal service. The invention therefore enables every imprint to be individually identified, and for reprint and refund imprints to be individually associated accordingly.

Moreover, it is advantageous to provide a second data field in the data set, and to write to this at the franking system with information about the particular type and/or the cause of the misprint. It is thus not only verifiable that a misprint occurred; it may also simply be established what misprint has occurred, so a corresponding consequence may be initiated using the type and/or cause of the misprint. If the type of misprint turns out to be one that falls into a predetermined category, this information may also be written to the first data field.

The systematics according to the invention are described again in the following using the individual categories of misprints.

Items of correspondence that were not printed, although they were debited in the franking system (misprint 1), may simply be determined by appropriate optical sensors and then are sorted out from the letter flow. Given these items of correspondences, the presence of the error is noted by an entry in the first data field. The type of error—here “misprint 1”—may also be entered in the first but also in the second data field. Within the framework of the file, the delivery service also receives the data set individualized via the identity number (ID), with all additional information about the corresponding item of correspondence, in particular with the debited postage amount. Since the imprint did not occur in spite of the debiting, and a delivery is accordingly precluded, the sender has a claim to reimbursement of the debited postage amount. The delivery service may make the reimbursement and has the assurance that it may monitor the legitimacy. Namely, if it establishes that it nevertheless did deliver the item of correspondence associated with the data set, in spite of the stored error, it may assert a claim to the postage amount from the sender. Such an instance allows conclusions of manipulation of the data set.

This same systematic applies to the “misprint 2”, illegible imprint, which may be registered with the same sensors. In contrast to the entirely absent imprint (“misprint 1”), the situation with the misprint 2 is not entirely clear; whether a sensor deems an imprint to be illegible may also be subject to the sensitivity of the sensor. It may also be the operator who perceives that the imprint is illegible. The postage amount and the code for the sensors are possibly legible; the logo of the sender is entirely defaced, however. Such misprints may be removed from the letter flow and be reimbursed corresponding to misprint 1.

In the event that the user detects the misprint 2, he may himself perform the writing to the data field via a keyboard, for example. The user also has the possibility of examining the preceding items of correspondence for the presence of such an illegible imprint and, if applicable, of removing these from the letter flow. In the event that a series of items of correspondence exhibits the same misprint 2, this is what is known as a batch error.

If the operator intervenes in the franking system and interrupts the flow given the occurrence of a malfunction, for example, this is the misprint 3. As in the preceding case of the misprint 2, the preceding items of correspondence may be examined automatically or manually as to whether there is a batch error. In this case, not only the current item of correspondence, but also the preceding items of correspondence would be provided with a corresponding entry in the first and second data field and be removed from the letter flow.

### BRIEF DESCRIPTION OF THE DRAWINGS

An embodiment of the method workflow according to the invention is shown in the flowchart depicted in the FIGURE.

### DESCRIPTION OF THE PREFERRED EMBODIMENTS

The method for mechanical franking of individual items of correspondence includes the determination of a postage amount associated with the item of correspondence, and the printing of a value imprint associated with the determined postage amount and of a code (in particular a one-dimensional or a two-dimensional barcode) onto the item of correspondence. The code includes an identity number individualizing the items of correspondence. Physical characteristics—such as weight and/or size of the item of correspondence, but also selected additional services and product properties—are taken into account to determine the postage amount. A data set associated with the item of correspondence is then created in the form of an imprint data set (ADS) and stored in a file (record) associated with the sender, wherein at least the identity number and the postage amount are written into the data set. The data set is ultimately provided to the delivery service in order to enable the delivery service to bill the postage amount to the sender. According to the invention, the presence of a possible incorrect imprint is registered. A first data field is thereby provided in the data set, which first data field is written to with an information about the presence of such a misprint.

The method is realized in a franking system that has a weighing device to determine the weight of an item of correspondence and to determine a postage amount associated with said item of correspondence. In addition, a printing device is present to print the value imprint corresponding to the postage amount and to print the code associated with the item of correspondence. A data set associated with the item of correspondence—in particular the ADS—is created with a control computer.

Furthermore, the franking system has a memory associated with the control computer to store the data set in a file (“record”) associated with the sender, wherein each data set includes the identity number of the item of correspondence and the postage amount that is to be debited from the sender by the delivery service using the data set. During processing, the data sets are first written into NVRAM and are stored in the record after the end of a stack processing.

According to the invention, a registration unit is associated with the control computer, which registration unit registers the presence of a misprint candidate and—given the presence of such a misprint candidate—writes to a first data field of the data set with information about the presence of said misprint candidate. The registration unit is additionally set up to establish the type and/or the cause of the misprint and to write to a second data field in the data set with information about the type and/or cause.

In the FIGURE, the procedure according to the invention is depicted as a chronological letter flow 1. The shown letter flow begins after the franking of an item of correspondence, thus after the determination and the printing of the value imprint and of the individual code. At the beginning, an imprint data set associated with the item of correspondence is created in step 2.

The debiting in a corresponding debiting module and the storage of the imprint data set subsequently take place in step 3. In addition to the conventional data fields 4, the structure of the imprint data set includes a first data field 5 according to the invention and a second data field 6 according to the invention. The data sets of the items of correspondence are stored in a record 7 associated with the sender.

In step 8, the presence of an incorrect imprint is registered. In the event that the misprint has been registered, which type of misprint is present is analyzed in steps 9, 10 and 11. In the event that no misprint has been registered, the process begins from the start and the next item of correspondence is franked (loop 12).

In step 9 it is determined whether it has been printed at all, or whether the “misprint 1” (debiting without printing) case is present. That may occur in the case of a letter jam or a power failure. The system may detect the misprint by means of a sensor or a plausibility check (double gap). In this instance, the first data field 5 of the ADS is accordingly written to with the “misprint 1” information in step 13 (arrow A). The item of correspondence is sorted out in step 14. The error may be remedied. In the decision diamond 15, a decision is made as to whether the next item of correspondence may be franked. If the answer to this is negative, additional steps may be introduced in step 16. In the error case 1, the user may desire a reprint or a reimbursement.

In step 10 it is determined whether the imprint is legible, or whether the “misprint 2” case (illegible imprint) exists. Possible causes of error are a clogged printer cartridge, unexpected consumption of ink, or a functionally incapable refill printer cartridge. In this case, the user is enabled to input the error cause in step 17. Using the letter flow of the previous items of correspondence, in the decision diamond 18 it may be established whether a recurring error (“batch error”) is present. In the event that this is the case (“no”), in step 19 the first data field of the ADS is in turn written to accordingly with the “misprint 2” information. In addition, the possibility exists to specify the cause of error, which is then noted in the second data field of the ADS. The item of correspondence is sorted out in step 20, and in the decision diamond 15 a decision is made again as to whether the next item of correspondence may be franked.

In the event that a batch error was detected in step 18, in step 21 the user receives the possibility to input the numbers N of the last illegible imprints. In that event, in step 22 the first data field (arrow A) and the second data field (arrow B) of the current ADS are written to with “misprint 2” and the cause. In addition, the ADS of the corresponding items of correspondence are searched from the record 7, corresponding to the specified numbers N, and are subsequently written to its respective first and second data field (arrow C). The N items of correspondence are sorted out in step 23. In the decision diamond 15, a decision is made as to whether the next item of correspondence may be franked. In the error case 2 as well, the user may desire a reprint or a reimbursement.

In step 11 it is determined whether the letter flow has been interrupted and the “misprint 3” (termination by the operator) is present. The user may have detected a mis-franking and stopped the system. The system detects the error case at the intervention of the user. If the mis-franking has occurred in a stack processing, a batch error is detected in step 24. If no batch error is present, in step 25 the first data field of the ADS is marked accordingly (arrow A). In addition, the possibility exists to note the error cause in the second data field of the ADS. The item of correspondence is sorted out in step 26. In the decision diamond 15, a decision is made as to whether the next item of correspondence may be franked.

In the event of a batch error, in step 27 an algorithm determines the number N of previous possible misprints. In step 28, the first data field (arrow A) of the current ADS are [sic] with the “misprint 3”. In addition to this, the ADS of the corresponding items of correspondences are searched from the record 7, corresponding to the specified numbers N, and are subsequently written to their respective first data field (arrow C). The item of correspondence is sorted out in step 29. In the decision diamond 15, a decision is made as to whether the next item of correspondence may be franked. In the error case 3 as well, the user may desire a reimbursement for the mis-franking(s).

In the error cases 2 or 3, the differentiation is thus made as to whether the mis-franking occurred during a stack processing. In the error case 2, the user determines the number of the last illegible frankings that are then likewise marked as an error case 3 in the ADS of the respective item of correspondence. In the error case 3, the last N ADS are likewise marked as error case 3 according to an algorithm.

After the end of the franking, the user is informed of the occurred error cases. He then has the possibility to trigger a follow-up action for every occurred instance of error. Among these follow-up actions are simply ignoring them, reprinting given error cases 1 or 2, and/or reimbursement in all three error cases.

If a reprint is desired, the data of the ADS are taken as a basis and reused. If a reimbursement is desired, this takes place electronically on the basis of the ADS. The ADS with the additional error data serves as evidence that one of the error cases 1 or 2 or 3 existed. The ADS is communicated by the franking system to the manufacturer data center and communicated further from there to the postal service, with the electronic request for reimbursement. The sending of a paper evidence is therefore superfluous.

Although modifications and changes may be suggested by those skilled in the art, it is the intention of the Applicant to embody within the patent warranted hereon all changes and modifications as reasonably and properly come within the scope of the Applicant's contribution to the art.

1. A franking system for franking of individual items of correspondence by a sender, said system comprising:
a weighing device that determines a weight of an item of correspondence and that determines a postage amount associated with the item of correspondence;
a printing device that prints a value imprint corresponding to the postage amount and that prints a code associated with the item of correspondence that represents a unique identity number onto the item of correspondence;
a control computer configured to generate a data set associated with the item of correspondence, said data set including the identity number of the item of correspondence and the postage amount that is to be debited on by a delivery service from the sender using the data set;
a memory, associated with the control computer, in which said computer is configured to store the data set in a file associated with the sender;
a registration unit associated with the control unit, said registration unit being configured to register a possibility of a presence of a misprint and, given the presence of a possible misprint, to write to a first data field of the data set with information about the presence of the possible misprint.

2. A franking system according to claim 1, wherein the registration unit is configured to establish at least one of a type and a cause of the misprint and to write to a second data field in the data set with information about at least one of the type and the cause.

3. A franking system according to claim 2, wherein the control computer is configured to access a functionality to retroactively modify the first and second data field of each data set of the file associated with the sender.

4. A franking system according to claim 3, wherein said access functionality comprises an input interface that enables a user input into said control computer.

5. A franking system according to claim 4, wherein the access functionality is configured to enable a selection and writing of all data sets stored in the file associated with the sender, with the individual data sets being respectively identified by the identity number.

6. A franking system according to claim 1, wherein the registration unit is configured to register, as a misprint, an imprint that was accomplished not or not completely accomplished by the printing device.

7. A franking system according to claim 1, wherein the registration unit is configured to register a termination of the franking process that occurred after generation of the data set, and to note said termination as a misprint in a data field of the data set.

8. A method for mechanical franking of individual items of correspondence by a sender, comprising:
determining a postage amount associated with the item of correspondence;
printing a value imprint associated with the determined postage amount and printing a code onto the item of correspondence, the code including an identity number that individualizes the items of correspondence;
generating a data set associated with the item of correspondence and storing the data set in a file associated with the sender, with the identity number and the postage amount being written into the data set;
providing the data set to the delivery service in order to enable the delivery service to bill the postage amount to the sender; and
registering a presence of a possible incorrect imprint, and writing information about the presence of such a misprint onto a first data field in said data set.

9. A method according to claim 8, comprising registering at least one of a type and a cause of the misprint is registered, and writing information about at least one of the type and cause of the misprint onto a second data field of the data set.

10. A method according to any of the claims 8 and 9, comprising selecting a single data set via an access functionality, from the data sets stored in the file associated with the sender, and modifying at least one of the first and second data fields of the data set, and again storing the modified data set in the file.

11. A method according to claim 8, comprising transmitting the file associated with the sender to the delivery service and, at the delivery service, comparing the delivered items of correspondence with the items of correspondence to be delivered.

12. A method according to claim 9, comprising transmitting the file associated with the sender to the delivery service via a service provider via the Internet.

13. A method according to claim 8, comprising, at the delivery service, using the file associated with the sender as a basis for reimbursements for incorrectly debited amounts, and checking the reimbursements by comparing the items of correspondence delivered by the delivery service with the items of correspondence to be delivered that result from the file associated with the sender.
